(19) United States
(12) Patent Application Publication
(10) Pub. No.: US 2025/0323445 A1
(43) Pub. Date: Oct. 16, 2025

(54) CONNECTOR

(71) Applicant: JAPAN AVIATION ELECTRONICS INDUSTRY, LIMITED, Tokyo (JP)

(72) Inventors: Atsushi KOBAYASHI, Tokyo (JP); Toshiro KOBUCHI, Tokyo (JP)

(73) Assignee: JAPAN AVIATION ELECTRONICS INDUSTRY, LIMITED, Tokyo (JP)

(21) Appl. No.: 19/070,738

(22) Filed: Mar. 5, 2025

(30) Foreign Application Priority Data
Apr. 16, 2024 (JP) 2024-066039

(51) Int. Cl. H01R 13/502; H01R 12/71; H01R 13/42

(52) U.S. Cl. CPC H01R 13/502; H01R 13/42; H01R 12/716

(57) ABSTRACT

The reinforcing bracket includes a pair of second terminals each of which is composed of a first extending portion extending from a position, which faces an intermediate region of a second guide portion and is on a lower end of an outer side surface of the second guide portion, toward a mating second guide portion, and a second extending portion extending from an end portion of the first extending portion toward a slit and a cutout portion. The cutout portion is formed on a position which does not interfere with corner portions of the protection portion and corner portions formed by the first guide portion and the second guide portions and accordingly, lower end sides of the corner portions of the protection portion and the corner portions formed by the first guide portion and the second guide portions are continuously connected to a bottom plate portion without any gaps.

### TECHNICAL FIELD

The present disclosure relates to a connector that is used in a manner to be mounted on a board as, for example, a board-to-board connector.

### BACKGROUND ART

FIG. 1 is an exploded perspective view of a receptacle connector that is described in Korea Patent Application Publication No. 10-2019-0000684(hereinafter, referred to as “Patent Literature 1”) as a prior art of the connector. FIG. 2 is a diagram illustrating a guide member of the receptacle connector described in Patent Literature 1, where FIG. 2(a) is a perspective view viewed from a first direction and FIG. 2(b) is a perspective view viewed from a second direction. The receptacle connector described in Patent Literature 1 includes an insulating body 210, and guide members 250 that are connected to respective both sides of the insulating body 210. The guide member 250 includes: an upper surface 610; and a first inside surface 632, a second inside surface 634, and a third inside surface 636, which extend from the upper surface 610 and curved toward the inside of the insulating body 210. Respective curved portions between the upper surface 610 and the first inside surface 632, between the upper surface 610 and the second inside surface 634, and between the upper surface 610 and the third inside surface 636 are continuously formed from a terminal end portion 633 of the first inside surface 632, which is curved toward the inside in the long side direction of the insulating body 210, to a terminal end portion 635 of the second inside surface 634, which is curved toward the inside in the long side direction of the insulating body 210. The guide member 250 further includes a contact portion 650 which extends from a first outside surface 642 and a second outside surface 644 to be brought into contact with electric terminals of a plug connector 100. The contact portion 650 includes a left contact portion 650a, which is formed in a manner to be extended from the first outside surface 642, and a right contact portion 650b, which is formed in a manner to be extended from the second outside surface 644, and the left contact portion 650a and the right contact portion 650b have the same shape as each other.

### SUMMARY OF THE INVENTION

In the receptacle connector described in Patent Literature 1, the guide members 250 are connected to respective both sides of the insulating body 210, and the contact portion 650 is provided closer to the central portion of the insulating body 210 in the long side direction than the terminal end portions 633 and 635. Thus, the contact portion 650 is positioned on the end portion of the guide member 250, being easily damaged by external forces or the like received, for example, when mating with and unmating from a mating connector.

To avoid this, one possible solution is to add a guide portion protecting the contact portion 650 further closer to the central portion of the insulating body 210 in the long side direction than the contact portion 650.

However, board-to-board connectors are often required to be miniaturized. Therefore, providing an additional guide portion elongates the guide member 250 in the long side direction of the insulating body 210 and results in elongation of the connector length, thus going against miniaturization.

A purpose of the present disclosure is to provide a connector in which a power source terminal can be prevented from being damaged while suppressing increase of the connector length and decrease in the connector strength.

A connector according to an example of the present embodiment includes: a housing which is made of resin; a pair of reinforcing brackets which are incorporated in both respective end portions in a long side direction of the housing; and first terminals which are arranged and held in the housing between the pair of reinforcing brackets. The housing includes an island-shaped portion which extends in the long side direction, a peripheral wall which is composed of a pair of side walls and a pair of end walls and surrounds the island-shaped portion, and an accommodating concave portion which is formed between the peripheral wall and the island-shaped portion and accommodates a fitting portion of a mating connector. The first terminals are positioned along a side surface in the long side direction of the island-shaped portion in the accommodating concave portion. Each of the pair of reinforcing brackets includes: a protection portion which covers a first region including two corner portions on an end portion in the long side direction of the island-shaped portion; a first guide portion which covers one of the pair of end walls; a pair of second guide portions which cover the pair of side walls from both ends of the first guide portion toward a mating reinforcing bracket up to a position aligned with the protection portion; a bottom plate portion which integrally connects the protection portion, the first guide portion, and the pair of second guide portions by covering the accommodating concave portion; a cutout portion which is formed in an intermediate region in an extending direction of each of the pair of second guide portions, and cuts out one of the pair of second guide portions from a part of an outer side surface of one of the pair of second guide portions to a position on an inner side surface, the position being close to the bottom plate portion, so as to expose a slit, the slit being formed in the housing; and a pair of second terminals each of which is composed of a first extending portion extending from a position, which faces the intermediate region and is on a lower end of an outer side surface of one of the pair of second guide portions, toward the mating second guide portion, up to a position facing the slit, and a second extending portion extending from an end portion of the first extending portion on an extension side toward the slit and the cutout portion. The cutout portion is formed on a position which does not interfere with the corner portions of the protection portion and a corner portion formed by the first guide portion and each of the pair of second guide portions and accordingly, lower end sides of the corner portions of the protection portion and the corner portion formed by the first guide portion and each of the pair of second guide portions are continuously connected to the bottom plate portion without any gaps.

### Effects of the Invention

According to the connector of the present disclosure, a power source terminal can be prevented from being damaged while suppressing increase of the connector length and decrease in the connector strength.

### BRIEF DESCRIPTION OF THE DRAWINGS

FIG. 1 is an exploded perspective view of a receptacle connector that is described in Patent Literature 1 as a prior art of the connector.

FIG. 2 is a diagram illustrating a guide member of the receptacle connector described in Patent Literature 1, where (a) is a perspective view viewed from a first direction and (b) is a perspective view viewed from a second direction.

FIG. 3 is a perspective view illustrating an example of a connector according to an embodiment of the present disclosure.

FIG. 4 is an enlarged plan view illustrating a connector 100A except for intermediate portion.

FIG. 5 is an enlarged diagram illustrating one end portion of the connector 100A in a long side direction except for a reinforcing bracket 80, where (a) is a plan view and (b) is a perspective view.

FIG. 6 is a sectional view of the connector 100A in a short side direction, where (a) is a sectional view taken along an E-E line in FIG. 4, (b) is a sectional view taken along an F-F line in FIG. 4, and (c) is a sectional view taken along a G-G line in FIG. 4.

FIG. 7 is a sectional view of the connector 100A in the long side direction, where (a) is a sectional view taken along an H-H line in FIG. 4, and (b) is a sectional view taken along an I-I line in FIG. 4.

FIG. 8 is a sectional view of the connector 100A in the short side direction, where (a) is a sectional view taken along a J-J line in FIG. 4, and (b) is a sectional view taken along a K-K line in FIG. 4.

FIG. 9 is a diagram illustrating the reinforcing bracket 80, where (a) is a perspective view and (b) is a plan view.

FIG. 10 is a diagram illustrating the reinforcing bracket 80, where (a) is an elevational view, (b) is a left side view, and (c) is a back view. FIG. 11 is a perspective view illustrating a mating connector to be fitted to the connector 100A.

FIG. 12 is a perspective view illustrating a fitting state of the connector 100A and the mating connector 200A.

FIG. 13 is an enlarged sectional view illustrating portions on which second terminals 86 of the reinforcing bracket 80 of the connector 100A are positioned in a state in which the connector 100A and the mating connector 200A are fitted and connected to each other.

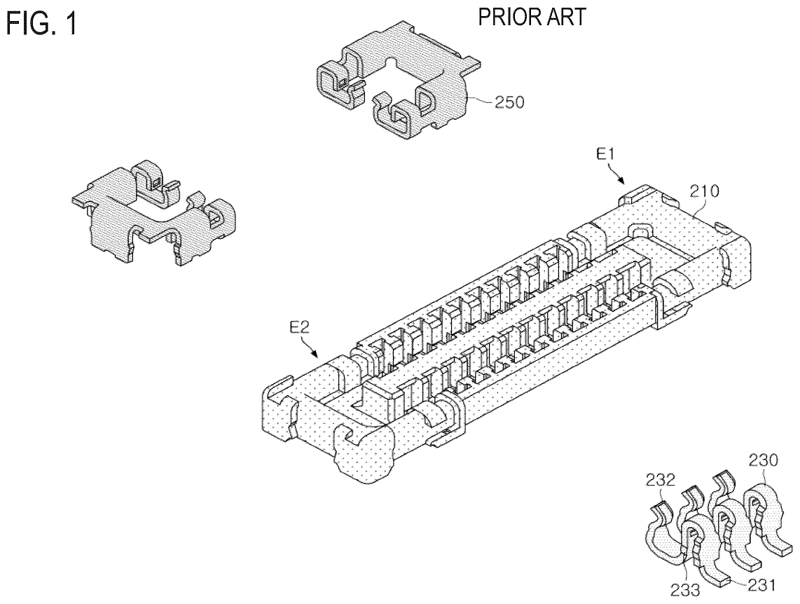

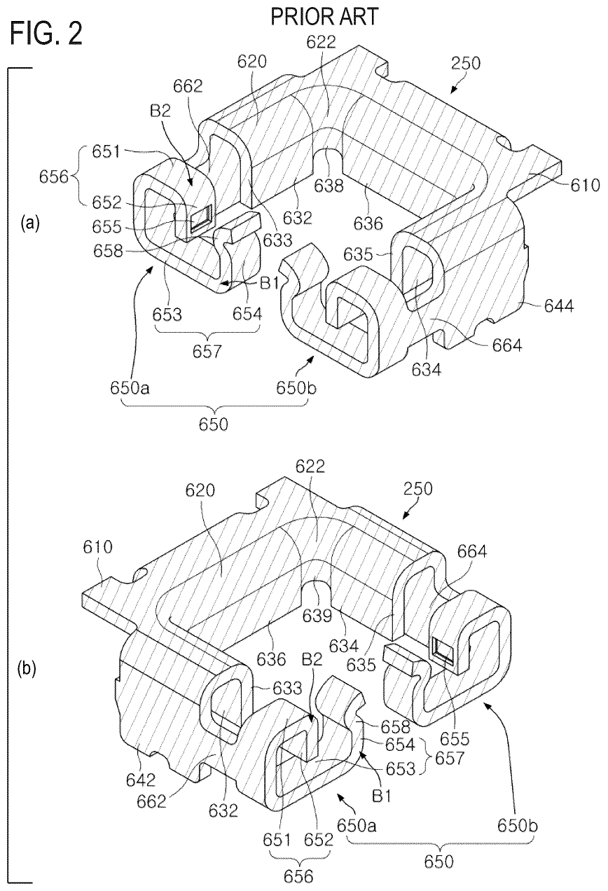

### DETAILED DESCRIPTION OF THE EMBODIMENTS

An embodiment of the present disclosure will be described with reference to the accompanying drawings.

### Connector

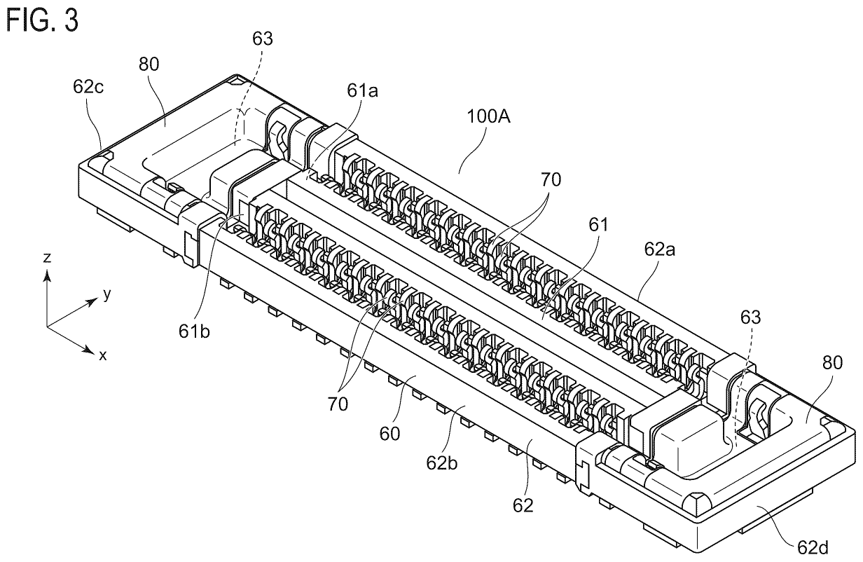

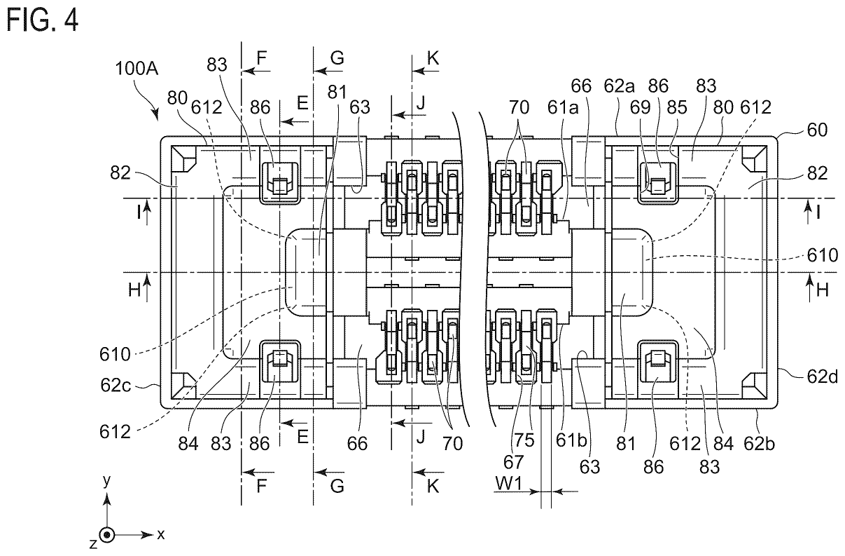

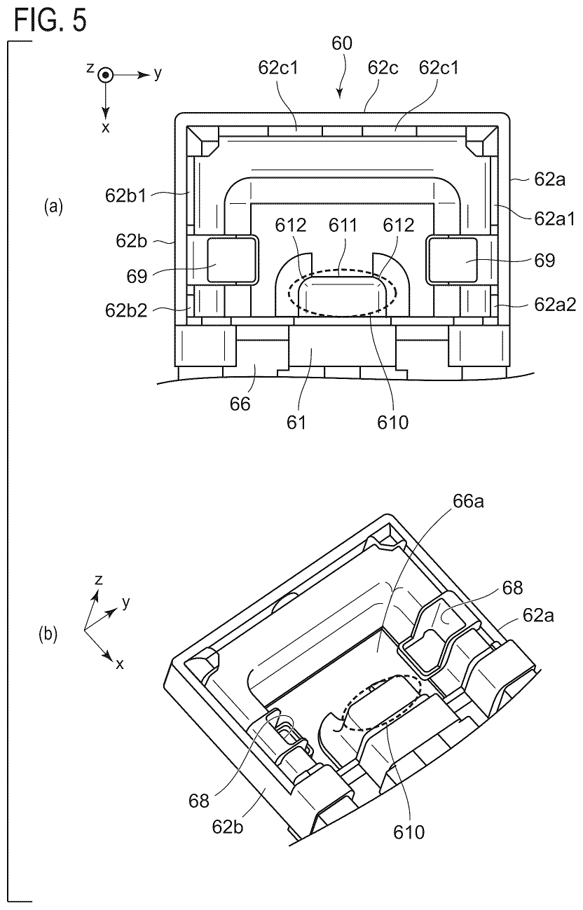

FIG. 3 is a perspective view illustrating an example of a connector according to the embodiment of the present disclosure. FIG. 4 is an enlarged plan view illustrating a connector 100A except for intermediate portion. FIG. 5 is an enlarged diagram illustrating one end portion of the connector 100A in a long side direction except for a reinforcing bracket 80, where FIG. 5(a) is a plan view and FIG. 5(b) is a perspective view. The connector 100A includes a housing 60, which is made of resin, a large number of first terminals 70, which are made of metal, and a pair of reinforcing brackets 80, as illustrated in FIG. 3.

### Housing 60

The housing 60 has a long and flat shape, and includes an island-shaped portion 61, a peripheral wall 62, and a bottom plate portion 66.

### (Island-Shaped Portion 61)

The island-shaped portion 61 has a substantially long rectangular parallelepiped shape which extends in the long side direction of the housing 60 (the x-axis direction in FIG. 3). The island-shaped portion 61 has two corner portions 612 on respective end portions 611, which are both end portions of the island-shaped portion 61, as illustrated in FIG. 5. In the present disclosure, a region including the two corner portions 612 in the end portion 611 (a region within the dotted line in FIG. 5) is referred to as a first region 610.

### (Peripheral Wall 62)

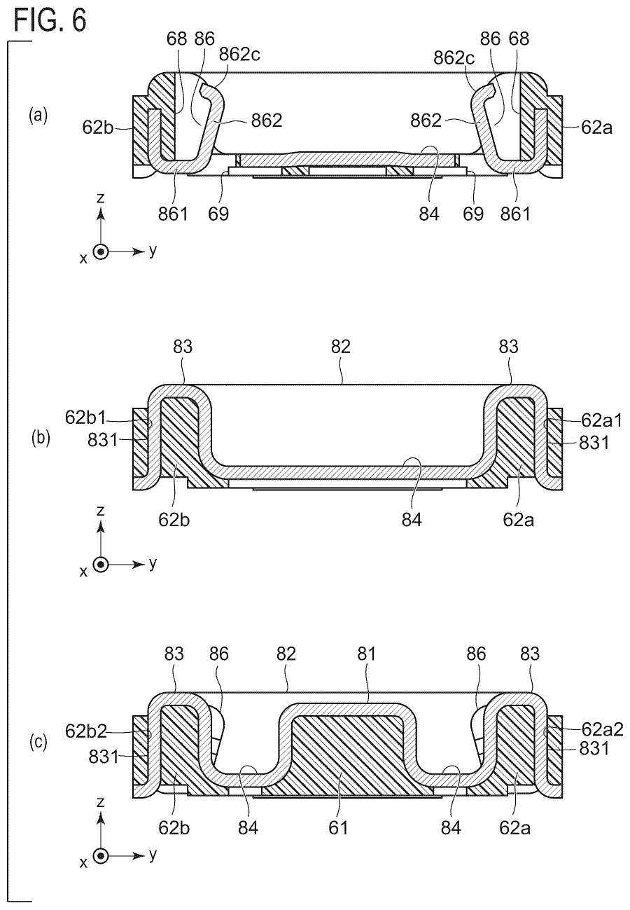

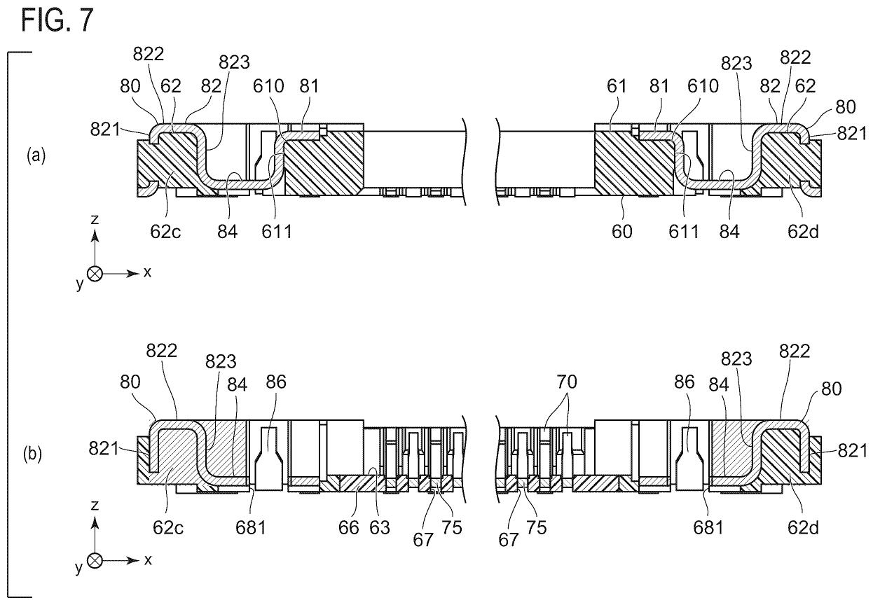

FIG. 6 is a sectional view of the connector 100A in a short side direction, where FIG. 6(a) is a sectional view taken along an E-E line in FIG. 4, FIG. 6(b) is a sectional view taken along an F-F line in FIG. 4, and FIG. 6(c) is a sectional view taken along a G-G line in FIG. 4. FIG. 7 is a sectional view of the connector 100A in the long side direction, where FIG. 7(a) is a sectional view taken along an H-H line in FIG. 4, and FIG. 7(b) is a sectional view taken along an I-I line in FIG. 4.

As illustrated in FIG. 3, the peripheral wall 62 is composed of a pair of side walls 62a and 62b, which are peripheral walls in the long side direction, and a pair of end walls 62c and 62d, which are peripheral walls in the short side direction (the y-axis direction in FIG. 3), and has a rectangular frame shape surrounding the island-shaped portion 61.

The side walls 62a and 62b of the peripheral wall 62 are formed by insert molding in this example where the inside of a second guide portion 83, which has an upside-down U shape in cross section, and the outside of a leg portion 831 are filled with insulating body, to form a substantially trapezoidal cross section, as illustrated in FIGS. 6(b) and 6(c). The leg portion 831 is thus positioned, whereby the side walls 62a and 62b have openings 62a1 and 62a2 and openings 62b1 and 62b2, as illustrated in FIG. 5.

The end walls 62c and 62d of the peripheral wall 62 are formed by insert molding in this example where the inside of a first guide portion 82, which has an upside-down U shape in cross section, and the outside of a leg portion 821 are filled with insulating body, to form a substantially trapezoidal cross section, as illustrated in FIG. 7. In the end walls 62c and 62d, the leg portion 821 is thus positioned, whereby the end wall 62c has an opening 62c1, as illustrated in FIG. 5. The end wall 62d has an opening 62d1 (not shown).

On the side walls 62a and 62b, slits 69, through which second terminals 86 described below can be inserted, are formed over the positions adjacent to an opening 66a of the bottom plate portion 66. The slit 69 is formed on a position opposed to a cutout portion 85, which will be described later, when a bottom plate portion 84 of the reinforcing bracket 80 is assembled to fit into an accommodating concave portion 63 of the housing 60. In respective side walls 62a and 62b, concave portions 68, which allow elastic deformation of the second terminals 86 when coming into contact with a mating connector 200A, are formed adjacent to the respective slits 69. The side walls 62a and 62b (FIG. 6(a)) in the regions where the slits 69 and the concave portions 68 are formed have a smaller cross section than the region where the slits 69 and the concave portions 68 are not formed (FIGS. 6(b) and 6(c)), and the thickness of the side walls 62a and 62b is thus partially thinner.

### (Bottom Plate Portion 66)

The island-shaped portion 61 and the peripheral wall 62 are connected by the bottom plate portion 66. Accordingly, the accommodating concave portion 63 for accommodating a fitting portion of the mating connector is formed between the island-shaped portion 61 and the peripheral wall 62. The bottom plate portion 66 has the opening 66a (FIG. 5 (b)) in the region surrounded by the end wall 62c (or the end wall 62d), which is provided on one of the both end portions in the long side direction (the x-axis direction in FIG. 5) of the bottom plate portion 66, the side walls 62a and 62b, and the first region 610, in this example.

### First Terminal 70

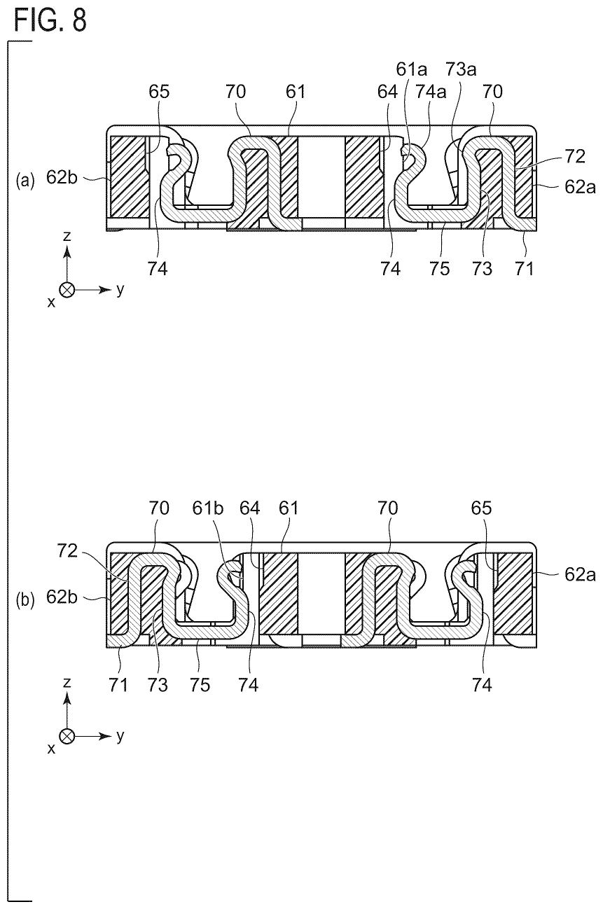

FIG. 8 is a sectional view of the connector 100A in the short side direction, where FIG. 8(a) is a sectional view taken along a J-J line in FIG. 4, and FIG. 8(b) is a sectional view taken along a K-K line in FIG. 4. The first terminal 70 (FIG. 3) is a cantilever terminal used, for example, as a signal terminal. The first terminals 70 are incorporated in the housing 60 by insert molding in this example. The first terminals 70 are positioned along side surfaces 61a and 61b in the long side direction of the island-shaped portion 61 in the accommodating concave portion 63 and arranged along the long side direction of the island-shaped portion 61 between the two reinforcing brackets 80 to be held by the housing 60.

The first terminals 70 are staggered in this example. When the arrangement of the first terminals 70 is counted from left to right in FIG. 4 as the first row, the second row, . . . , a cross section of the connector 100A on a portion on which the first terminals 70 in an odd-numbered row are located and a cross section of the connector 100A on a portion on which the first terminals 70 in an even-numbered row are located are as shown in FIG. 8(a) and FIG. 8(b) respectively.

The shape of a single first terminal 70 is the same in both FIGS. 8(a) and 8(b). The first terminal 70 includes a connection portion 71, a standing portion 72, a first contact portion 73, a second contact portion 74, and a coupling portion 75. The connection portion 71 is positioned on a bottom surface side (−z direction side in FIG. 8) of the housing 60 so as to be connected to a board by soldering. The standing portion 72 is raised from the connection portion 71. The first contact portion 73 is bent back from the standing portion 72. The second contact portion 74 is opposed to the first contact portion 73. The coupling portion 75 couples lower ends of the first contact portion 73 and the second contact portion 74 to each other. A free end of the second contact portion 74 is bent to be closer to the first contact portion 73 in a semi-circular arc shape, thus forming a bent portion 74a. A protrusion portion 73a is formed in a protruding manner on the first contact portion 73 so that the protrusion portion 73a is opposed to the bent portion 74a.

Here, in the portion in which the first terminals 70 in an odd-numbered row are located, concave portions 64 and 65 are formed at the side surface 61a and an inner surface of the side wall 62b of the island-shaped portion 61 respectively, and these concave portions 64 and 65 allow elastic deformation of respective second contact portions 74 of the first terminals 70. Further, in the portion in which the first terminals 70 in an even-numbered row are located, the concave portions 64 and 65 are formed at the side surface 61b and an inner surface of the side wall 62a of the island-shaped portion 61 respectively, and these concave portions 64 and 65 allow elastic deformation of respective second contact portions 74 of the first terminals 70. Here, a slit 67 is formed in a portion on which the coupling portion 75 of each first terminal 70 is positioned on the bottom plate portion 66, positioned on the bottom surface of the accommodating concave portion 63, of the housing 60 and the coupling portion 75 is positioned in the slit 67, as illustrated in FIG. 4. This configuration allows elastic deformation of the coupling portion 75 along with the second contact portion 74.

### Reinforcing Bracket 80

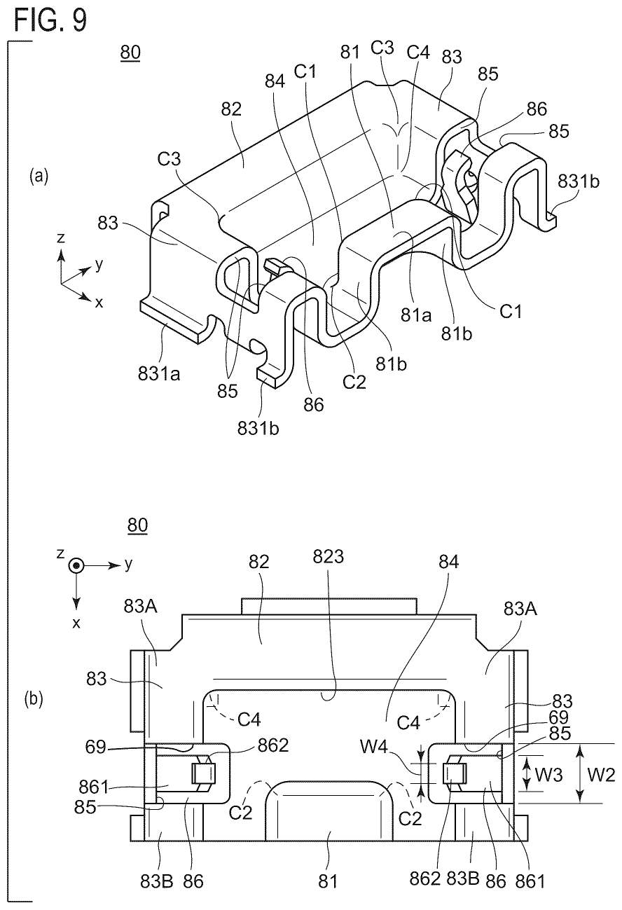

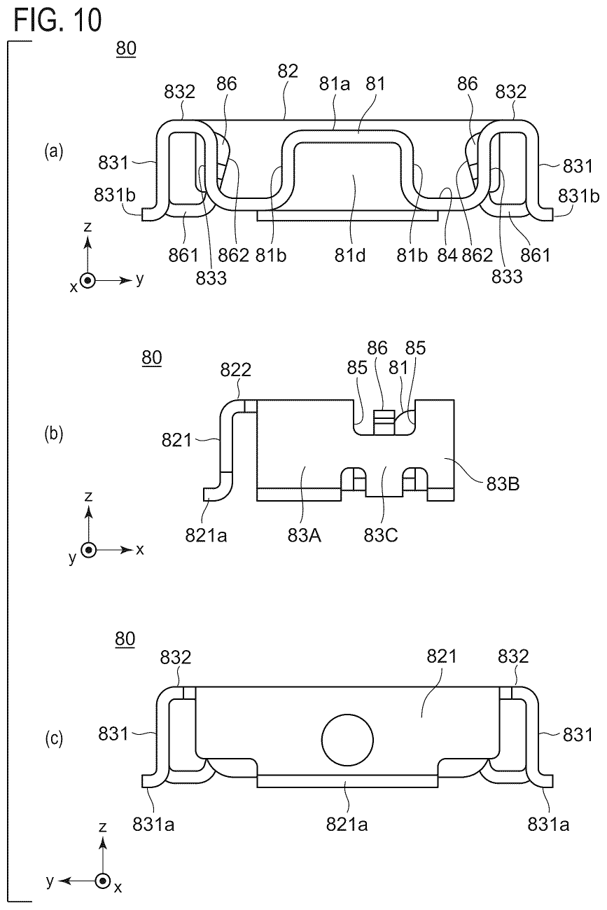

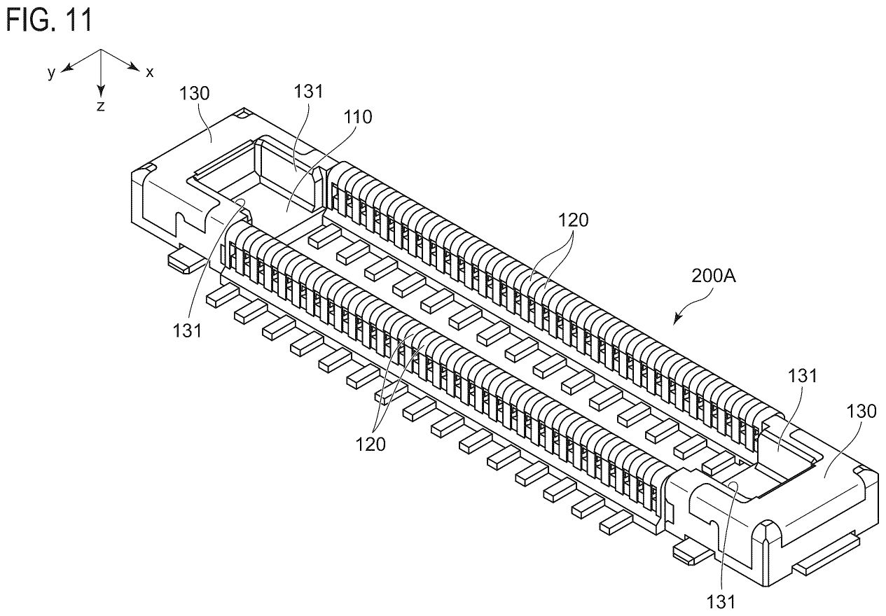

FIG. 9 is a diagram illustrating the reinforcing bracket 80, where FIG. 9(a) is a perspective view and FIG. 9(b) is a plan view. FIG. 10 is a diagram illustrating the reinforcing bracket 80, where FIG. 10(a) is an elevational view, FIG. 10(b) is a left side view, and FIG. 10(c) is a back view. The reinforcing brackets 80 are incorporated in both respective end portions in the long side direction of the housing 60. The reinforcing brackets 80 are incorporated in the housing 60 by insert molding in this example. The reinforcing bracket 80 includes a protection portion 81, the first guide portion 82, a pair of second guide portions 83, the bottom plate portion 84, and a pair of second terminals 86, as illustrated in FIG. 9.

### (Protection Portion 81)

The protection portion 81 covers the first region 610 (FIG. 5) including the two corner portions 612 in the end portion 611 in the long side direction of the island-shaped portion 61. The protection portion 81 protrudes upward (+z direction in FIG. 9) from the bottom plate portion 84 at an opening portion of the angular U shape formed by the first guide portion 82 and the pair of second guide portions 83. The protection portion 81 has an upper plate portion 81a, a pair of side plate portions 81b, and a rear surface plate portion 81d (FIG. 10(a)) that are continued without any gaps. Thus, the protection portion 81 has a box shape whose front surface side (+x direction side in FIG. 9(a)) and lower surface side (−z direction side in FIG. 9(a)) are opened.

### (First Guide Portion 82)

The first guide portion 82 is composed of the leg portion 821 on the outer side, an upper plate portion 822, and a leg portion 823 on the inner side, and covers the end wall 62c or the end wall 62d, as illustrated in FIG. 7. The first guide portion 82 and the pair of second guide portions 83 protrude upward (+z direction in FIG. 9) from the bottom plate portion 84, and each of the three sides forming the angular U shape has an upside-down U shape in cross section.

The lower end (−z direction side in FIG. 10(b)) of the leg portion 821 is provided with a connection portion 821a. The connection portion 821a is positioned slightly below (−z direction side in FIG. 10(a)) the bottom plate portion 84 and has a shape bent outward in parallel with the bottom plate portion 84.

### (Second Guide Portion 83)

The pair of second guide portions 83 cover the side walls 62a and 62b from both ends of the first guide portion 82 toward a mating reinforcing bracket 80 up to a position aligned with the protection portion 81, as illustrated in FIGS. 9 and 10. The second guide portion 83 is composed of the leg portion 831 on the outer side, an upper plate portion 832, and a leg portion 833 on the inner side, and covers the side wall 62a or the side wall 62b.

The lower end (−z direction side in FIG. 10(a)) of the leg portion 831 is provided with connection portions 831a and 831b. Each of the connection portions 831a and 831b is positioned slightly below (−z direction side in FIG. 10(a)) the bottom plate portion 84 and has a shape bent outward in parallel with the bottom plate portion 84.

### (Bottom Plate Portion 84)

The bottom plate portion 84 integrally connects the protection portion 81, the first guide portion 82, and the pair of second guide portions 83 by covering a predetermined region on each of both end portions of the bottom plate portion 66 in the long side direction (the x-axis direction in FIG. 3). Respective lower end sides (−z direction side in FIG. 9(a)) of the leg portion 823, the pair of leg portions 833, the rear surface plate portion 81d, and the pair of side plate portions 81b are integrally connected with the bottom plate portion 84.

Thus, the first guide portion 82 and the pair of second guide portions 83 form the angular U shape in plan view, as illustrated in FIG. 9(b), and the protection portion 81 is positioned in the inside of the angular U shape of the first guide portion 82 and the pair of second guide portions 83 forming the angular U shape in plan view. The first guide portion 82 and the pair of second guide portions 83 are formed by drawing, in this example. The protection portion 81 is formed by drawing, in this example. Namely, the first guide portion 82 and the pair of second guide portions 83, and the protection portion 81 are formed by double drawing of sheet metal, in this example. By the double drawing of sheet metal, the bottom plate portion 84 is formed so that there is no gap of sheet metal between the bottom plate portion 84 and each of the first guide portion 82, the pair of second guide portions 83, and the protection portion 81, except for the cutout portion 85 which will be described later.

### (Cutout Portion 85)

Each of the pair of second guide portions 83 has the cutout portion 85 in an intermediate region of the extension direction (+x direction in FIG. 9), as illustrated in FIG. 9. The cutout portion 85 is provided to cut out the second guide portion 83 with a second width W2 from the leg portion 831 on the upper plate portion 832 side through the upper plate portion 832 to a position slightly inside the bottom plate portion 84 from the leg portion 833, in this example. Here, the size of the cutout portion 85 may be appropriately adjusted depending on the relation with the second terminal 86. For example, the length of the cutout of the cutout portion 85 does not have to reach the position slightly inside the bottom plate portion 84 from the leg portion 833, but the cutout portion 85 may be configured to cut out up to a position close to the bottom plate portion 84 in the leg portion 833. The cutout portion 85 cuts out the second guide portion 83 so that the slit 69 formed in the housing 60 is exposed when the reinforcing bracket 80 is incorporated into the housing 60.

With the cutout portion 85 formed, the second guide portion 83 is composed of three regions: second guide portions 83A and 83B, which have an upside-down U shape in cross section, and a second guide portion 83C, which couples the second guide portions 83A and 83B and forms part of the leg portion 831 of the second guide portion 83, as illustrated in FIG. 10(b).

When the protection portion 81, the first guide portion 82, and the second guide portions 83 are formed by drawing, the reinforcing bracket 80 is formed from a single sheet of sheet metal. When the reinforcing bracket 80 is formed from a single sheet of sheet metal by drawing, the thickness of the sheet metal is often uneven, especially in the drawn portion (bent portion). In terms of this unevenness in plate thickness, the thickness tends to be thinnest, for example, at corner portions and corner parts. Therefore, it is preferable to form the cutout portion 85 at a position that avoids, as much as possible, the corner portion formed by the first guide portion 82 and the second guide portion 83 and the corner portion formed by the protection portion 81, from the viewpoint of ensuring rigidity.

By forming the cutout portion 85 on the position of the arrangement described above, it is possible to more reliably protect the second terminal 86 from damage and also to contribute to ensuring the rigidity of the reinforcing bracket 80.

### (Second Terminal 86)

The second terminal 86 is a terminal used, for example, as a power source terminal. The second terminal 86 includes a first extending portion 861 and a second extending portion 862. The second terminal 86 serves as a cantilever which is fixed on the first extending portion 861 side.

The first extending portion 861 extends from a position, which faces the cutout portion 85 in an intermediate region on the extension side (+x direction side in FIG. 9) of the second guide portion 83 and is on a lower end side of the leg portion 831 of the second guide portion 83, toward a mating second guide portion 83, up to a position facing the slit 69. The first extending portion 861 is formed to have the width (third width W3) which is larger than the first width W1 (FIG. 4), which is the width of the first terminal 70, and smaller than the width (second width W2) of the cutout portion 85, as illustrated in FIG. 9. The first extending portion 861 is positioned inside the slit 69. The housing 60 has the slit 69, which allows the elastic deformation of the first extending portion 861 along with the second extending portion 862.

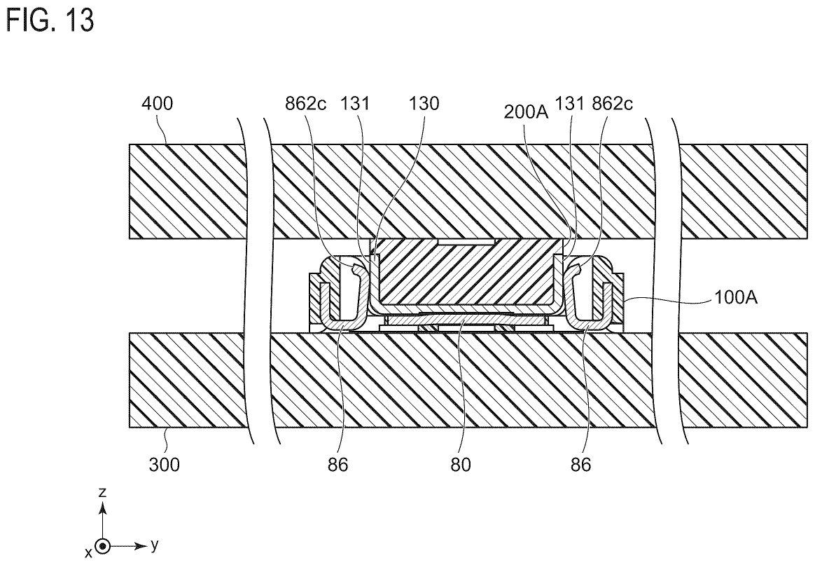

The second extending portion 862 extends upward from the end portion on the extension side of the first extending portion 861 (towards the slit 69 and the cutout portion 85). On the tip end of the second extending portion 862, a bent portion 862c (FIG. 6(a)) bent toward the leg portion 831 is formed. At least a part of the second extending portion 862 on the bent portion 862c side is on a position slightly closer to the mating second terminal 86 from the region of the cutout portion 85 in the second guide portion 83. In other words, the second extending portions 862 of the two second terminals 86, which form cantilevers, extend from the slits 69 and the cutout portions 85 upward (+z direction side in FIG. 13) through the accommodating concave portion 63 of the housing 60 to a contact portion 131 of the mating connector 200A, and are positioned so as to sandwich the contact portion 131. Accordingly, the tip end sides of the second extending portions 862 are positioned toward the inside of the housing 60 in the short side direction (the y-axis direction in FIG. 13). The second extending portion 862 is formed to have the width (fourth width W4) which is smaller than the third width W3 of the first extending portion 861. The housing 60 has the concave portions 68, which allows the second terminals 86 to come into contact with the contact portion 131 of the mating connector and elastically deform.

The reinforcing brackets 80 having the above-described shape are incorporated in both respective end portions in the long side direction of the housing 60. Accordingly, the first regions 610, each of which includes the two corner portions 612 in the end portion 611 in the long side direction of the island-shaped portion 61 of the housing 60, are covered by the respective protection portions 81, as illustrated in FIGS. 6 and 7. The end walls 62c and 62d of the peripheral wall 62 are covered by the first guide portions 82. The side walls 62a and 62b of the peripheral wall 62 are covered by the second guide portions 83 in regions of a predetermined length extending from both ends of the end walls 62c and 62d toward the mating end walls 62d and 62c. Namely, the reinforcing bracket 80 is incorporated in the housing 60 at a position covering the end wall 62c (or the end wall 62d), parts of the side walls 62a and 62b, and the first region 610, in a state in which the bottom plate portion 84 is fitted in the both end sides of the accommodating concave portion 63 of the housing 60 in the long side direction.

### Mating Connector

FIG. 11 is a perspective view illustrating the mating connector 200A to be fitted to the connector 100A. The mating connector 200A illustrated in FIG. 11 includes a housing 110, which is made of resin, terminals 120, and reinforcing brackets 130.

The housing 110 has an elongated rectangular frame shape and a large number of terminals 120 are arranged and held on each of a pair of long side portions of the housing 110. The respective reinforcing brackets 130 are arranged on both end portions in a long side direction (the x-axis direction in FIG. 11) of the housing 110, and the terminals 120 and the reinforcing brackets 130 are both incorporated in the housing 110 by insert molding in this example.

### Fitting of Connector and Mating Connector

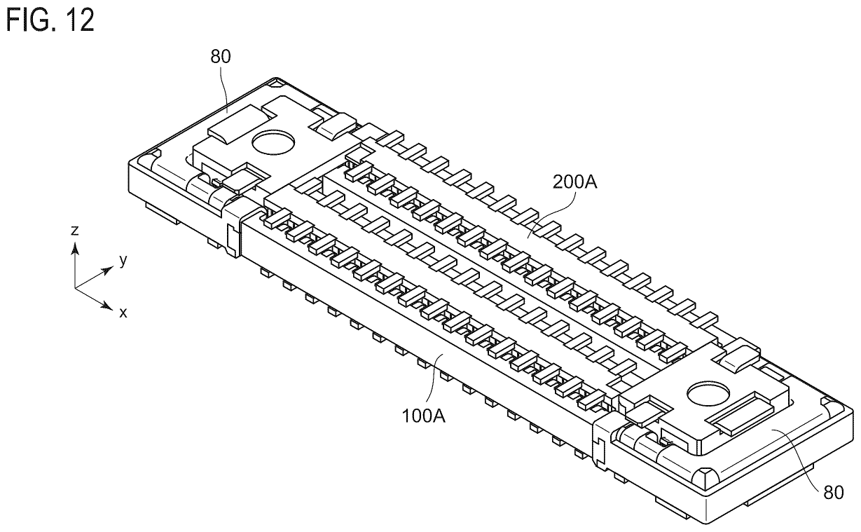

FIG. 12 is a perspective view illustrating a fitting state of the connector 100A and the mating connector 200A. FIG. 12 does not illustrate respective boards on which the connector 100A and the mating connector 200A are mounted. In a fitted state of the connector 100A and the mating connector 200A, the mating connector 200A is fitted into the accommodating concave portion 63 of the connector 100A so as to be connected with the connector 100A.

FIG. 13 is an enlarged sectional view illustrating portions on which the second terminals 86 of the reinforcing bracket 80 of the connector 100A are positioned in a state in which the connector 100A and the mating connector 200A are fitted and connected to each other. FIG. 13 shows boards 300 and 400 on which the connector 100A and the mating connector 200A are mounted respectively. As illustrated in FIG. 13, the second extending portions 862 of the two second terminals 86 included in the reinforcing brackets 80 of the connector 100A are brought into contact with the contact portions 131 included in the reinforcing brackets 130 of the mating connector 200A.

The configuration of the connector 100A as an example of the connector according to the present disclosure has been described above. Further, the configuration of the mating connector 200A and the fitting state with the mating connector 200A have been described. According to the configuration of the connector 100A of the present disclosure, the following can be said.

The reinforcing bracket 80 incorporated in each of both end portions of the connector 100A includes the protection portion 81 covering the first region 610, the first guide portion 82 covering the end wall 62c (or the end wall 62d), and the pair of second guide portions 83 covering the side walls 62a and 62b. The reinforcing bracket 80 includes the cutout portions 85. Each of the cutout portions 85 is formed in the intermediate region in the extending direction of the second guide portion 83, and cuts out the second guide portion 83 from a part of the outer side surface (leg portion 831) of the second guide portion 83 to a position close to the bottom plate portion 84 in the inner side surface (leg portion 833) so as to expose the slit 69 formed in the housing 60. Accordingly, the provision of the cutout portion 85 contributes to reducing the rigidity of the reinforcing bracket 80.

However, the reinforcing bracket 80 includes the bottom plate portion 84 which is not found in Patent Literature 1 and integrally connects the protection portion 81, the first guide portion 82, and the pair of second guide portions 83. Here, the cutout portions 85 are formed in the second guide portions 83, but the lower end sides of the second guide portions 83 are connected to each other. That is, the connected structure of the second guide portions 83A, 83B, and 83C is maintained. In particular, a reinforcing bracket, which is formed three-dimensionally from a single sheet of sheet metal by double drawing, has an uneven thickness, with the thinnest thickness at the corner portions thereof. Therefore, the strength of the corner portions of the protection portion 81 (a pair of corner portions C1 illustrated in FIG. 9(a)) and the corner portions formed by the first guide portion 82 and the pair of second guide portions 83 (a pair of corner portions C3 illustrated in FIG. 9(a)) is reduced, making the corner portions more easily deformed and damaged. The cutout portion 85 of the present disclosure is formed on a position that does not interfere with the corner portions of the protection portion 81 (the corner portions C1) and the corner portions formed by the first guide portion 82 and the pair of second guide portions 83 (the corner portions C3). Accordingly, the lower end sides of the corner portions C1 of the protection portion 81 (a pair of corner portions C2 illustrated in FIGS. 9(a) and 9(b)) and the lower end sides of the corner portions C3 formed by the first guide portion 82 and the pair of second guide portions 83 (a pair of corner portions C4 illustrated in FIGS. 9(a) and 9(b)) are continuously connected to the bottom plate portion 84 without any gaps, which has an advantageous effect of preventing deformation and damage of the protection portion 81, the first guide portion 82, and the second guide portions 83.

Although the rigidity of the reinforcing bracket 80 is reduced compared to the case without the cutout portion 85, the limited position of the cutout portion 85 allows the reinforcing bracket 80 to have a structure in which the protection portion 81, the first guide portion 82, and the pair of second guide portions 83 are integrally connected to the bottom plate portion 84, which ensures high rigidity of the reinforcing bracket 80.

The reinforcing bracket 80 is provided with the pair of second terminals 86. The second terminal 86 is composed of the first extending portion 861 extending from a position, which faces the intermediate region in the extending direction of the second guide portion 83 and is on the lower end of the leg portion 831 of the second guide portion 83, toward the mating second guide portion 83, up to the position facing the slit 69; and the second extending portion 862 extending from the end portion of the first extending portion 861 on the extension side toward the slit 69 and the cutout portions 85. That is, the second terminal 86 is positioned between the second guide portion 83A and the second guide portion 83B, rather than at the end portion of the guide member as in the contact portion 650 of the connector of Patent Literature 1. Thus, the second terminal 86 is configured to be protected from damages by the second guide portion 83A and the second guide portion 83B.

The reinforcing bracket 80 of the present disclosure does not employ the configuration in which a guide portion is added by increasing the extension length of the second guide portion 83 so as to prevent damage to the second terminal 86. The reinforcing bracket 80 has the cutout portion 85 in a region corresponding to the second guide portion 83C, which is a part of the region of the second guide portion 83, and the second terminal 86 is positioned between the second guide portion 83A and the second guide portion 83B. Therefore, although the second terminal 86 is prevented from being damaged, the overall length of the connector 100A is not increased.

Thus, there are integrated metal having a significantly large area on both end portions of the housing 60 and the housing 60 is accordingly protected and reinforced, and the strength of the reinforcing brackets 80 themselves is ensured. Therefore, a connector that is not damaged by external force and the like received during mating with and unmating from a mating connector and thus has excellent strength can be obtained, for example. Further, the second terminal 86 included in the reinforcing bracket 80 is also configured to be protected from damage, which is caused by external force and the like received during mating with and unmating from a mating connector, by the second guide portions 83A and 83B. According to the connector of the present disclosure, the second terminal 86, which can be used as a power source terminal, can be prevented from being damaged in a manner to suppress increase of the connector length and decrease in the connector strength.

The embodiment of the present disclosure has been described above. Although the reinforcing bracket 80 has been described as being formed by double drawing, the reinforcing bracket 80 of the present disclosure is not limited to this. Other manufacturing methods may be employed as long as the reinforcing bracket 80 having the same configuration can be formed. Although the connector 100A has been described as being obtained by insert molding, the connector 100A of the present disclosure is not limited to this. The connector 100A may be realized by other manufacturing methods as long as a similar connector can be obtained. In addition, it goes without saying that the above-described connector 100A can be modified as appropriate without departing from the spirit and scope of the present disclosure.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A connector comprising:
a housing which is made of resin;
a pair of reinforcing brackets which are incorporated in both respective end portions in a long side direction of the housing; and
first terminals which are arranged and held in the housing between the pair of reinforcing brackets, wherein
the housing includes an island-shaped portion which extends in the long side direction, a peripheral wall which is composed of a pair of side walls and a pair of end walls and surrounds the island-shaped portion, and an accommodating concave portion which is formed between the peripheral wall and the island-shaped portion and accommodates a fitting portion of a mating connector,
the first terminals are positioned along a side surface in the long side direction of the island-shaped portion in the accommodating concave portion,
each of the pair of reinforcing brackets includes
a protection portion which covers a first region including two corner portions on an end portion in the long side direction of the island-shaped portion,
a first guide portion which covers one of the pair of end walls,
a pair of second guide portions which cover the pair of side walls from both ends of the first guide portion toward a mating reinforcing bracket up to a position aligned with the protection portion,
a bottom plate portion which integrally connects the protection portion, the first guide portion, and the pair of second guide portions by covering the accommodating concave portion,
a cutout portion which is formed in an intermediate region in an extending direction of each of the pair of second guide portions, and cuts out one of the pair of second guide portions from a part of an outer side surface of one of the pair of second guide portions to a position on an inner side surface, the position being close to the bottom plate portion, so as to expose a slit, the slit being formed in the housing, and
a pair of second terminals each of which is composed of a first extending portion extending from a position, the position facing the intermediate region and being on a lower end of an outer side surface of one of the pair of second guide portions, toward the mating second guide portion, up to a position facing the slit; and a second extending portion extending from an end portion of the first extending portion on an extension side toward the slit and the cutout portion, and
the cutout portion is formed on a position which does not interfere with the corner portions of the protection portion and a corner portion formed by the first guide portion and each of the pair of second guide portions and accordingly, lower end sides of the corner portions of the protection portion and the corner portion formed by the first guide portion and each of the pair of second guide portions are continuously connected to the bottom plate portion without any gaps.

2. The connector according to claim 1, wherein
at least a part of the second extending portion on a tip end side is on a position closer to the mating second terminal than a region of the cutout portion.
